(19) United States
(12) Patent Application Publication
(10) Pub. No.: US 2023/0112521 A1
(43) Pub. Date: Apr. 13, 2023

(54) EDUCATIONAL GAME

(71) Applicants: Vance Arthur Manchester, Gresham, OR (US); Jolyn Manchester, Gresham, OR (US)

(72) Inventors: Vance Arthur Manchester, Gresham, OR (US); Jolyn Manchester, Gresham, OR (US)

(21) Appl. No.: 17/869,756

(22) Filed: Jul. 20, 2022

Related U.S. Application Data
(60) Provisional application No. 63/254,442, filed on Oct. 11, 2021.
(60) Provisional application No. 63/284,639, filed on Dec. 1, 2021.

(51) Int. Cl. G09B 19/02; G09B 5/02

(52) U.S. Cl. CPC G09B 19/025; G09B 5/02

(57) ABSTRACT

A system and method for education game for kids that help learning basic math skills. The method includes the steps of presenting on a screen generated by an interface module, a number of blocks of different shapes. Each block on the screen touches at least one adjacent block. Moves has to be made from a first selected block to next consecutive blocks to form a path, wherein a selected block must be in touch with last selected block.

### CROSS-REFERENCE TO RELATED APPLICATIONS

This application claims priority to the U.S. provisional patent application Ser. No. 63/254,442 filed on 11 Oct. 2021 and 63/284,639 filed on 1 Dec. 2021, both of which are incorporated herein by reference in their entirety.

### FIELD OF INVENTION

The present invention relates to an educational game for kids, and more particularly, the present invention relates to a block game for learning basic math and problem-solving skills.

### BACKGROUND

A variety of games are available for kids for learning and recreational activities. Game-based learning has been widely adopted for kids in many countries. The educational games make learning fun and help the children to focus and pay attention. Learning with games is a great way to build social skills, problem-solving skills, and math skills in kids. Moreover, learning with games also builds better body-mind coordination.

A need is therefore appreciated for an improvised education game for kids that is both fun and builds mathematical and problem-solving skills.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an educational game for kids that can help learn basic math and problem-solving skills.

It is another object of the present invention that the education game is fun to play.

It is still another object of the present invention that two or more kids can play the educational game.

It is yet another object of the present invention that the educational game is economical to manufacture.

It is a further object of the present invention that the education game can be versatile.

In one aspect, disclosed is a system and method for game-based learning that allows kids to learn math, such as calculations with fun. The method includes the steps of providing an interface on a user device. Through the interface can be presented blocks of a variety of shapes. The blocks are planar in shape and thin, all the blocks can be of the same width. The sides of the blocks can be straight or curved, and each block can have the sides of unequal lengths. Each shape has a points value associated with it, wherein the points value of a block is proportional to the number of sides the block has. The screen of the interface can be filled with the blocks of different shapes. The number of shapes can be fixed which can be any number, such as the blocks of ten selected shapes. The blocks can be positioned horizontally, such that the top surfaces of the blocks are in a horizontal plane.

In one aspect, a user can select a block at a bottom of the screen and can continue selecting the blocks upwards, wherein the user can select only those blocks that are touching the last selected block. The system is configured to keep a cumulative total of the points values of the selected blocks and the time elapsed from selecting the first block. The system can also track the number of moves made by the player i.e., moving to the next block and the total number of blocks selected. The system can calculate a score based on the total points, the number of moves, and the duration of the game.

In one aspect, the disclosed system can display the aforesaid values and the score on the display through the interface. The statistics from different games by the same or different players can be pooled for statistical analysis and determining group ranks and global ranks. The arrangement of the blocks of the same and different shapes on a screen of the interface can be varied to generate different levels. The user can jump to the next levels by scoring above the predefined scores for each level. The system may allow a user to play a level more than one time to improve his score, however, the number of attempts may affect the group and global ranks.

In one aspect, added conditions can be imposed, such as touching a block of a particular shape “n” times, wherein the value of n can be predetermined by the system or can be determined by mutual consent among players.

In one aspect, the system can incorporate embodiments of artificial intelligence, wherein the system can learn from the games and can devise new rules and conditions for games and algorithms to arrange blocks in a screen to keep the game challenging with more levels and fun. For example, the system can devise a new rule of touching a triangular block “n” time to complete a level, the value of “n” can be variable and determined by the system using artificial intelligence.

In one aspect disclosed is a method for an education game, the method implemented within a system comprising a processor and a memory, the method comprising the steps of providing an interface, by an interface module implemented within the system and upon execution by the processor; generating, by a game module implemented within the system and upon execution by the processor, ten or more blocks to be arranged in a screen based on a predetermined algorithm, wherein a plurality of blocks of the ten or more blocks are of a plurality of shapes, wherein each block of the ten or more blocks touches at least one adjacent block of the ten or more blocks; receiving, through the interface, a selection of a first block from the ten or more blocks; and upon selection, coupling a first feature to the first block.

In one implementation, the method further comprises the steps of assigning a points value to each of the ten or more blocks, wherein the points value is proportional to a number of sides of the respective block.

In one implementation, the points value is disposed on an exposed surface of the each of the ten or more blocks. The ten or more blocks comprises hundred blocks and the plurality of shapes comprises a star, a hexagon, a pentagon, a diamond, a trapezoid, a square, a crescent moon, and a half circle.

In one implementation, the first feature is an icon of a predetermined shape and color.

In one implementation, the method further comprises the steps of receiving, through the interface, a selection of a second block from the ten or more blocks, wherein the first block and the second block touch each other; and upon the selection, coupling a second feature to the second block, wherein the first feature and the second feature are same.

In one implementation, the method further comprises the steps of receiving, through the interface, a selection of a third block from the ten or more blocks, wherein the second block and the third block touch each other; and upon the selection, coupling a third feature to the third block, wherein the third feature and the second feature are same. The method further comprises the steps of counting, by the game module, a total of the points value associated with the first block, the second block, and the third block to obtain a sum; and displaying the sum on the screen. The method further comprises the steps of receiving, through the interface, a selection of a n block from the ten or more blocks, wherein a value of n is predetermined, wherein the n block and a block selected before the n block from the ten or more blocks touch each other; and upon the selection, coupling a n feature to the n block, wherein the n feature and the second feature are same.

In one aspect, disclosed is a system for an education game, the system comprising a processor and a memory, the system configured to implement a method comprising the steps of providing an interface, by an interface module implemented within the system and upon execution by the processor; generating, by a game module implemented within the system and upon execution by the processor, ten or more blocks to be arranged in a screen based on a predetermined algorithm, wherein a plurality of blocks of the ten or more blocks are of a plurality of shapes, wherein each block of the ten or more blocks touches at least one adjacent block of the ten or more blocks; receiving, through the interface, a selection of a first block from the ten or more blocks; and upon selection, coupling a first feature to the first block.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows the blocks of different shapes that can be used for a game, according to an exemplary embodiment of the present invention.

FIG. 2 is a top view of a gameboard made using the blocks, wherein each block touches at least one adjacent block, according to an exemplary embodiment of the present invention.

FIG. 3 is a top view of a gameboard made using the blocks, wherein each block touches at least one adjacent block, each block has a points value on its top surface, according to an exemplary embodiment of the present invention.

FIG. 4 shows one method for playing the game using the gameboard shown in FIG. 2, according to an exemplary embodiment of the present invention.

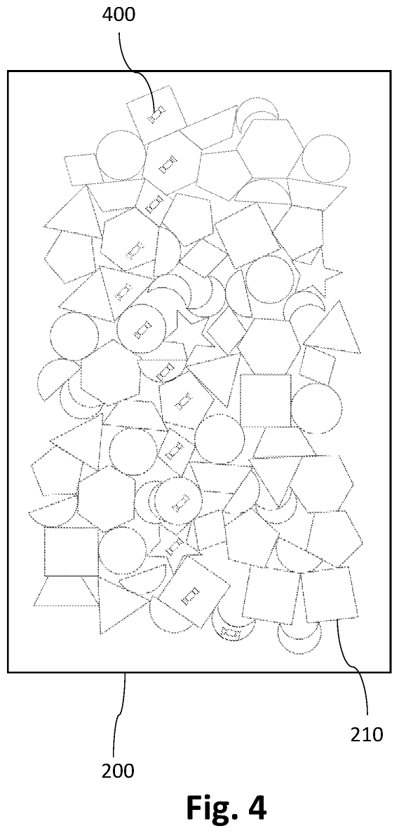

FIG. 5 shows gameplays of two players on the gameboard shown in FIG. 4, according to an exemplary embodiment of the present invention.

FIG. 6 shows one method for playing the game using the gameboard shown in FIG. 3, according to an exemplary embodiment of the present invention.

FIG. 7 shows a screen of an interface provided on a user device, according to an exemplary embodiment of the present invention.

FIG. 8 is a block diagram showing an architecture of the disclosed system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

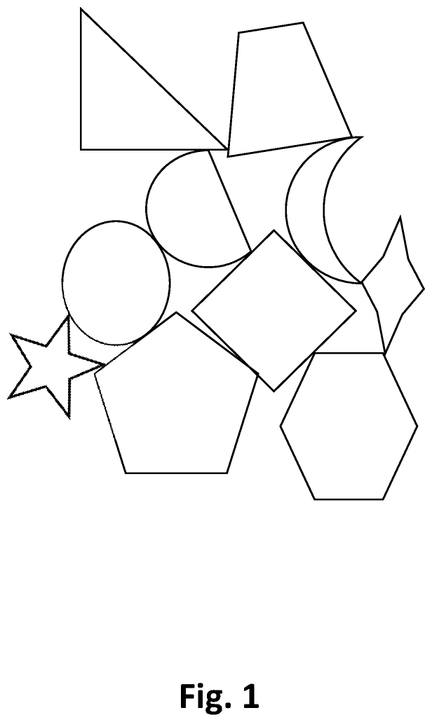

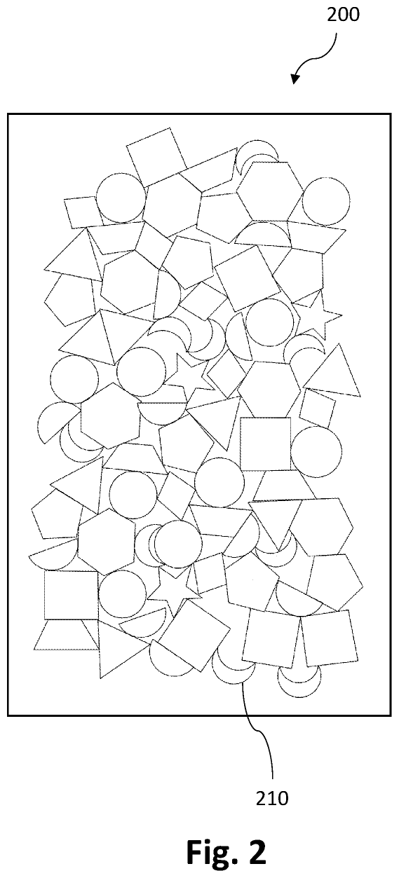

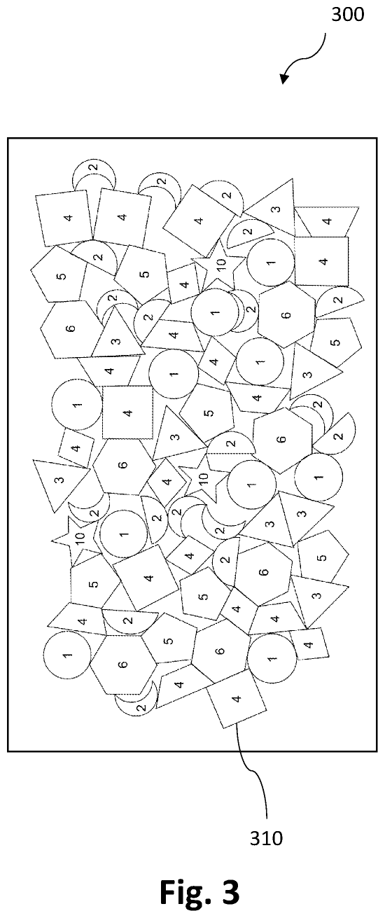

Disclosed is a system and method for an educational game for kids. Also, disclosed is a game board for kids that help the kids to learn with fun. The kids can learn and improve their math skills and problem-solving skills. The kids can be motivated to do better and to find new ways to solve challenges. The disclosed game provides blocks of the same and different shapes. For example, blocks of at least ten different shapes can be provided and more than one block can be of a given shape. FIG. 1 shows examples of different shapes of the blocks and includes triangular, square, hexagon, pentagon, star, and the like. Any shape can be chosen for the blocks and the blocks of a variety of shapes are within the scope of the present invention. The blocks can be planar and thin in geometry, all the blocks can be of the same width. Each block can have a top surface and a bottom surface. On the top surface can be provided a number, the value of which can be proportional to a number of sides of the respective block. The rear surface can be plain. The user can choose any number of shapes for gameplay. For example, the user can choose ten shapes. The blocks can be randomly arranged on a flat surface, such that at least one side of each block can touch a side of an adjacent block, to form a game board. The top surfaces of the blocks can face up or down, when the blocks face up, the numbers on the top surfaces of the blocks are visible. The top surfaces of the blocks can lie in a horizontal plane. In one case, around 100 blocks can be used to make the game board. FIG. 2 shows an exemplary embodiment of the game board 200. It can be seen in FIG. 2 that at least one side of each block can touch another adjacent block, and the blocks are arranged randomly. For example, in each gameplay, the blocks can be arranged randomly. In FIG. 2, the game board 200 has the blocks 210 having their bottom surfaces up, wherein the bottom surface is plain without any number. FIG. 3 shows a game board 300 in which the top surfaces of the blocks 310 face up and the numbers on each block are visible.

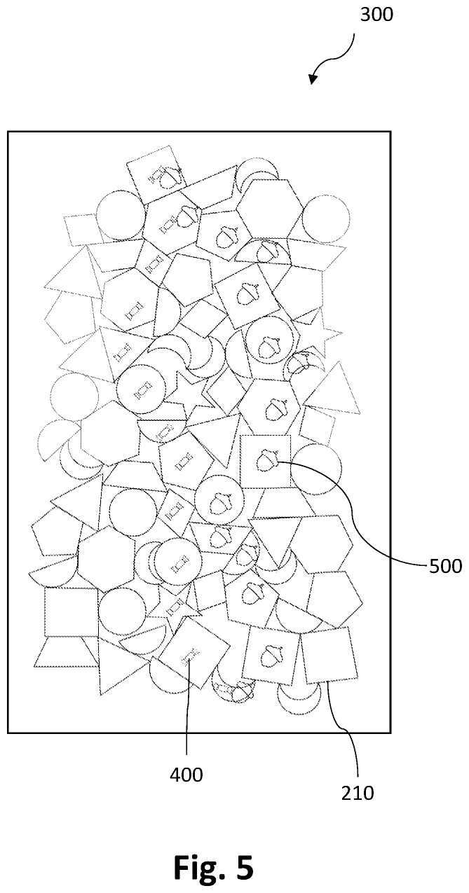

The game can be played in a variety of ways. For example, the user has to reach from a starting point which can be the first block on the front side of the game board to an endpoint which can be the last block on the opposite side of the game board (or between the nearest and the farthest blocks on the game board). A player who makes the least number of moves in reaching from the starting to the endpoint can be a winner. It is to be noted that a user can move only to an adjacent block, i.e., the block touching the last selected block. FIG. 3 shows the game board 200 and playing pieces 400 which are candies, and on each selected block is placed a candy, and the path taken by the player from starting to end is shown by the candies 400. FIG. 5 shows the path taken by another player, as shown by candies 500. Both the paths i.e., candies 400 and 500, can be compared, and based on a predetermined criterion, one player can be declared a winner.

In another version of the gameplay, the number on the top surface of the block can be the points value for that block i.e., the points value for a block can be equal to the number of sides of the block. For example, a star has 10 sides with a value of ten points, a hexagon has 6 sides for a value of 6 points, a pentagon has five sides with a value of 5 points, diamond, trapezoid, square all have four sides and each has a value of 4 points, triangles have 3 sides and a value of 3 points, Crescent Moons and Half Circles have 2 sides each and a value of 2 points, and a circle has 1 side for a point value of 1 point.

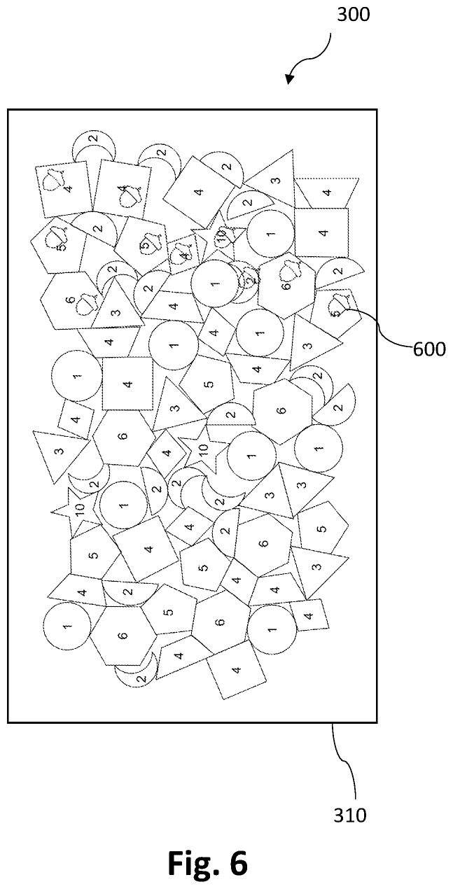

In particular gameplay, each user can be provided with a fixed number of moves. For example, each player in the gameplay can be provided with a fixed number of player pieces, wherein the player pieces of different players can be of different shapes or colors. For example, in the gameplay with two players, red color ten player-pieces can be provided to player A and yellow color ten player pieces can be provided to player B. To select the block, the player can put their player piece on the selected block. The player may not be allowed to unselect a block after placing the player piece on the block. The player has to make ten moves i.e., select ten blocks consecutively wherein the user can jump only to an adjacent block for the next move, and the adjacent block should touch the last selected block. The points value of all the ten selected blocks by the player can be summed, and the player who has the maximum sum of points value can be a winner. FIG. 6 shows the game board 300 and ten candies 600 as placed on 10 blocks to form a path.

In certain embodiments, the player pieces can be any solid object, such as but not limited to dried beans, popcorn kernels, candy, and the like provided that the size of the player pieces should be smaller than the size of the smallest block. The player pieces can be placed on the selected blocks and the trail of the player pieces can show the path taken by the player. In one case, each distinct shape can be of a distinct color.

In certain embodiments, the gameplay can have different rules to keep the gameplay challenging. Such rules can be predefined or made by mutual agreement between the players in gameplay. For example, by selecting a block of a particular shape at least twice, a player can select a block of a particular shape only once during one turn.

The regular game can be played using three mathematical operations i.e., addition, subtraction, or multiplication. In the regular game, the numbered sides are all facing up on all of the shapes. This game can be timed and the player that finishes with the lowest time, after all of the rounds are completed, can be the winner. In the timed frame, there can be an alternative method. This method is used as the kids become better with their math strategy skills. Each player will get a minute to place their pieces.

At the end of each round of the gameplay, the players can take time to look at the path taken by them and determine if there was a better path that could have been taken. This may be an essential part of the gameplay. This may allow the kids at every level of development to be able to build problem-solving skills, reasoning, and logic skills. The most efficient way to build such skills is to take a look at what each player could have done better by moving their pieces onto a different path. In other words, was there a path to follow to make either fewer moves to reach the goal from Starting to the endpoint, or to add up more points in the same amount of moves for the regular game.

In one exemplary embodiment, four players can Play the board game. One to four players can take a hundred blocks of ten different shapes and place them on a flat surface to form the game board. Each block in the game board must touch at least one adjacent block as shown in FIG. 2. The top surface of the blocks that has numbers on it must face up. Each player can get a fixed or variable number of playing pieces that they use in playing that game. The first player places their first piece on to any outside shape that is on the outer edge/border of the board. Then the player places the next piece onto a block touching the last selected block. Each time a piece is placed on a selected block, the points value of the blocks adds up to a cumulative sum or total. For example, the player can start with a hexagon block (6 points), move to a second touching block a pentagon (5 points), and then move to a third half circle block (2 points). The total score can be calculated as 6+5+2. This continues until the players finish laying down all of their pieces and a final score can be calculated and compared between the players. The game can be played in multiple turns, and for each turn, a player can select the blocks of unique shapes only, i.e., two blocks of the same shape cannot be selected in a turn. Moreover, the player may not select a block twice in a single turn. Such rules can be varied to keep the gameplay challenging and fun, and any such rules are within the scope of the present invention. For example, in certain advanced methods, a player can have a fixed time, such as one minute to select the blocks and when the time is over, the total of the points values of the selected blocks can be calculated.

In certain embodiments, each gameplay can have multiple rounds, such as about 3 to 5 rounds based on the player's preferences. At the end of the game, if the game is timed, the player whose time is the lowest in total after the times are tallied can be the winner. If the game is not timed, the player who tallied the fewest number of moves at the end of the game can be the winner. If the game is timed with the minute rule, the winner is the player with the highest number of points.

In certain embodiments, disclosed is a method for gameplay for beginners in which a starting block A and an end block B can be selected. This game is played for 3 to 5 rounds. The shapes can be turned over so that the numbers are not visible i.e., the bottom surfaces are up. One to four players take a hundred of the ten different shapes and place them on a flat surface. The players take turns selecting the blocks and placing their pieces on the selected blocks. The goal of this game is for each player to move as few pieces as possible starting from block A to get to block B. Each of the players takes their turn moving their pieces starting from block A to block B. The total number of blocks can be tallied, based on the number of blocks that each of the players moved onto, to get their piece from block A to block B. The player that moved onto the fewest number of blocks to get from block A to block B is the winner of that round. At the end of the game, the total number of moves that each player made can be tallied. The player that moved on the fewest number of blocks can be the winner.

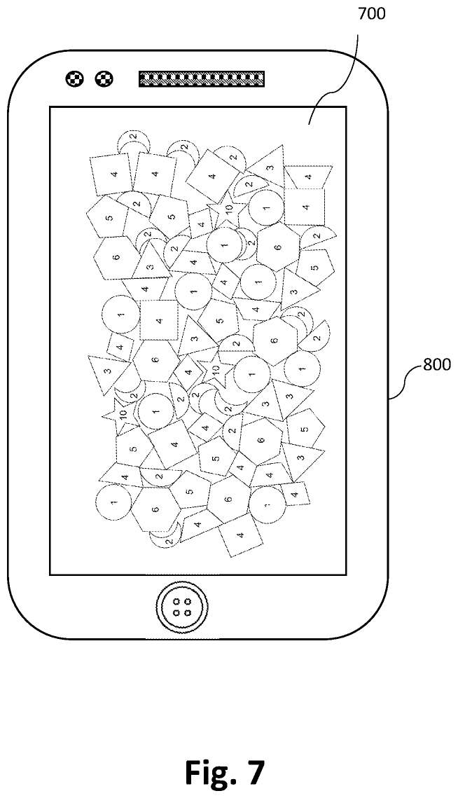

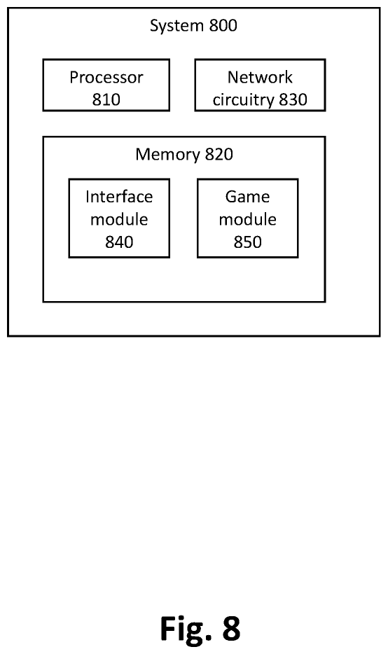

In certain embodiments, the aspects of the present invention can be implemented in an electronic environment, such as a system shown in FIG. 8. The system 800 can include a processor 810 and a memory 820. A network circuitry 830 can also be provided for connecting to an external network. The memory can include an interface module 840 and a game module 850. The modules can be software, program, code, or a set of instructions that upon executing by the processor perform the disclosed methodology of playing the educational game. The system can be implemented as a smartphone, tablet computer, laptop, desktop computer, and the like. The system can have a display for presenting the interface to the players. The system can also include an input device for receiving input from players. In one case, a touch input can be provided to receive input from a player. The touch inputs are well known in electronic devices, such as a smartphone. The disclosed system can also be implemented as a server to which different player devices can connect. The server can be a single server or a group of servers. The group of servers can be at one location or scattered at different locations. The server includes cloud servers, and any other implementation of the servers, and all such implementations of the servers are within the scope of the present invention. An exemplary embodiment of interface 700 is shown in FIG. 7.

The interface module 840 upon execution by the processor can provide an interface on a player device. It is to be noted that the player device and the system can be the same or different. Moreover, certain steps of the gameplay can be executed on the server and certain steps of the gameplay can be executed on the player device.

The interface can include a screen showing the blocks of different shapes. The blocks can be used to prepare a game board presented on a second screen of the interface. The selection of the shapes for the blocks can be made by the players or by the game module. The blocks of selected shapes can be arranged randomly throughout the screen wherein each block is in contact with at least one adjacent block in the screen. An option can be provided by the interface to show the number on the blocks, wherein the number is the points value of the block and is equal to the number of sides of the block. The concepts of numbers, points, and summing of the points have been described above and thus not repeated here.

The interface can also provide a variety of playing pieces to choose from. The players can also create playing pieces or modify the existing ones. To select a block on the game board, the user can simply touch on top of the block, and the selected block can be marked by the playing piece associated with the user. The gameplay can be played using a variety of ways as discussed above for physical game boards and hence not repeated here.

In certain embodiments, also disclosed is a game in which each player has 4 or 5 pieces that are assigned point values between 10 and 25 that they move across the disclosed game board. The players add up the points as they move across the connected shapes until the point total for that piece is completed. In other words, moving from a pentagon (5 points) onto a star (10 points) and then onto a hexagon (6 points)=16 points. A piece is forced to stop moving when either all of the points are used up or whether it cannot be moved to another piece that would exceed the pieces point value. The object of the game is for a player to land their piece, on its last move, on top of the shape where the opponent has one of their pieces on. Then the player removes the opponent's piece from the board and takes the point value for that piece and adds it to their total. For example, if player A moves one of their pieces on his last move on top of a shape where the opponent's piece with a value of 25 sits then the opponent's piece is moved from the board and player A gets 25 points. Each player takes turns moving their pieces across the game board. The moves are timed up to 45 seconds per move. As the players advance in skill level the time for each move is shortened.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for an education game, the method implemented within a system comprising a processor and a memory, the method comprising the steps of:
providing an interface, by an interface module implemented within the system and upon execution by the processor;
generating, by a game module implemented within the system and upon execution by the processor, ten or more blocks to be arranged in a screen based on a predetermined algorithm, wherein a plurality of blocks of the ten or more blocks are of a plurality of shapes, wherein each block of the ten or more blocks touches at least one adjacent block of the ten or more blocks;
receiving, through the interface, a selection of a first block from the ten or more blocks; and
upon selection, coupling a first feature to the first block.

2. The method according to claim 1, wherein the method further comprises the steps of:
assigning a points value to each of the ten or more blocks, wherein the points value is proportional to a number of sides of the respective block.

3. The method according to claim 2, wherein the points value is disposed on an exposed surface of the each of the ten or more blocks.

4. The method according to claim 2, wherein the ten or more blocks comprises hundred blocks and the plurality of shapes comprises a star, a hexagon, a pentagon, a diamond, a trapezoid, a square, a crescent moon, and a half circle.

5. The method according to claim 1, wherein the first feature is an icon of a predetermined shape and color.

6. The method according to claim 2, wherein the method further comprises the steps of:
receiving, through the interface, a selection of a second block from the ten or more blocks, wherein the first block and the second block touch each other; and
upon the selection, coupling a second feature to the second block, wherein the first feature and the second feature are same.

7. The method according to claim 6, wherein the method further comprises the steps of:
receiving, through the interface, a selection of a third block from the ten or more blocks, wherein the second block and the third block touch each other; and
upon the selection, coupling a third feature to the third block, wherein the third feature and the second feature are same.

8. The method according to claim 7, wherein the method further comprises the steps of:
counting, by the game module, a total of the points value associated with the first block, the second block, and the third block to obtain a sum; and
displaying the sum on the screen.

9. The method according to claim 7, wherein the method further comprises the steps of:
receiving, through the interface, a selection of a n block from the ten or more blocks, wherein a value of n is predetermined, wherein the n block and a block selected before the n block from the ten or more blocks touch each other; and
upon the selection, coupling a n feature to the n block, wherein the n feature and the second feature are same.

10. A system for an education game, the system comprising a processor and a memory, the system configured to implement a method comprising the steps of:
providing an interface, by an interface module implemented within the system and upon execution by the processor;
generating, by a game module implemented within the system and upon execution by the processor, ten or more blocks to be arranged in a screen based on a predetermined algorithm, wherein a plurality of blocks of the ten or more blocks are of a plurality of shapes, wherein each block of the ten or more blocks touches at least one adjacent block of the ten or more blocks;
receiving, through the interface, a selection of a first block from the ten or more blocks; and
upon selection, coupling a first feature to the first block.

11. The system according to claim 10, wherein the method further comprises the steps of:
assigning a points value to each of the ten or more blocks, wherein the points value is proportional to a number of sides of the respective block.

12. The system according to claim 11, wherein the points value is disposed on an exposed surface of the each of the ten or more blocks.

13. The system according to claim 11, wherein the ten or more blocks comprises hundred blocks and the plurality of shapes comprises a star, a hexagon, a pentagon, a diamond, a trapezoid, a square, a crescent moon, and a half circle.

14. The system according to claim 10, wherein the first feature is an icon of a predetermined shape and color.

15. The system according to claim 11, wherein the method further comprises the steps of:
receiving, through the interface, a selection of a second block from the ten or more blocks, wherein the first block and the second block touch each other; and
upon the selection, coupling a second feature to the second block, wherein the first feature and the second feature are same.

16. The system according to claim 15, wherein the method further comprises the steps of:
receiving, through the interface, a selection of a third block from the ten or more blocks, wherein the second block and the third block touch each other; and
upon the selection, coupling a third feature to the third block, wherein the third feature and the second feature are same.

17. The system according to claim 16, wherein the method further comprises the steps of:
counting, by the game module, a total of the points value associated with the first block, the second block, and the third block to obtain a sum; and
displaying the sum on the screen.

18. The system according to claim 16, wherein the method further comprises the steps of:
receiving, through the interface, a selection of a n block from the ten or more blocks, wherein a value of n is predetermined, wherein the n block and a block selected before the n block from the ten or more blocks touch each other; and
upon the selection, coupling a n feature to the n block, wherein the n feature and the second feature are same.
